(19) United States
(12) Patent Application Publication
(10) Pub. No.: US 2016/0234720 A1
(43) Pub. Date: Aug. 11, 2016

(54) WLAN RATE ESTIMATION

(71) Applicant: QUALCOMM Incorporated, San Diego, CA (US)

(72) Inventors: Peter BARANY, San Diego, CA (US); Dan ZHANG, San Diego, CA (US); Venkata Ramanan VENKATACHALAM JAYARAMAN, San Diego, CA (US); Divya RAVICHANDRAN, San Diego, CA (US); Rohit KAPOOR, San Diego, CA (US)

(21) Appl. No.: 14/850,647

(22) Filed: Sep. 10, 2015

Related U.S. Application Data
(60) Provisional application No. 62/114,453, filed on Feb. 10, 2015.

(51) Int. Cl. H04W 28/16

(52) U.S. Cl. CPC H04W 28/16; H04W 84/12

(57) ABSTRACT

Methods, systems, and devices are described for estimating wireless local area network (WLAN) capacity. In accordance with the present disclosure, one or more applications associated with a mobile device may request WLAN capacity estimation in order to maximize the use of available network resources. In some examples, the mobile device may obtain WLAN information from a WLAN modem driver associated with a WLAN modem via an application program interface (API) to calculate the WLAN capacity. The WLAN capacity may include capacity of an access point (AP) associated with the mobile device to support additional users or data over one or more downlink and/or uplink channels. Accordingly, the mobile device may optimize data download or upload times by efficiently managing the available resources.

### CROSS-REFERENCE TO RELATED APPLICATION(S)

This application claims priority to U.S. Provisional Application Ser. No. 62/114,453, entitled, “WLAN RATE ESTIMATION,” and filed on Feb. 10, 2015, which is assigned to the assignee hereof and hereby expressly incorporated by reference herein in its entirety.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., Long Term Evolution (LTE) system).

By way of example, a wireless multiple-access communications system may include a number of base stations, each simultaneously supporting communication for multiple communication devices, which may be otherwise known as user equipment (UEs), mobile devices or stations (STAs). A base station may communicate with the communication devices on downlink channels (e.g., for transmissions from a base station to a UE) and uplink channels (e.g., for transmissions from a UE to a base station).

As cellular networks have become more congested, operators are beginning to look at ways to maximize the use of available network resources. One approach may include offloading cellular and data traffic to wireless local area network (WLAN) network by utilizing unused resources, for example, unused bandwidth on the downlink and/or uplink channels on the WLAN network. However, utilizing the unused resources requires accurate estimation of the network capacity. Conventional methods fail to accurately and efficiently calculate the WLAN network capacity based on existing procedures and algorithms.

### SUMMARY

Systems, methods, and apparatuses for estimating wireless local area network (WLAN) capacity are disclosed. In accordance with aspects of the present disclosure, one or more applications associated with a mobile device may request WLAN capacity estimation in order to maximize the use of available network resources. In some examples, the mobile device may obtain WLAN information from a WLAN modem (e.g., from a driver of the WLAN modem) via an application program interface (API) to calculate the WLAN capacity. The WLAN capacity may include capacity of an access point (AP) associated with the mobile device to support additional users or data over one or more downlink and/or uplink channels. Accordingly, the mobile device may optimize data download or upload times by efficiently managing the available resources based on the estimated WLAN capacity.

According to a first set of examples, a method for wireless communications is described. The method may include triggering, by an application on a mobile device, estimation of a WLAN capacity associated with the mobile device. Based on the triggering, the method may obtain WLAN information from a WLAN modem of the mobile device and estimate the WLAN capacity during a polling period based on the WLAN information. In some examples, the method may further provide the WLAN capacity to the application on the mobile device for adjusting air-interface operations associated with the application.

According to a second set of examples, an apparatus for wireless communication is described. The apparatus may comprise means for triggering, by an application on a mobile device, estimation of a WLAN capacity associated with the mobile device. Based on the means for triggering, the apparatus may further include means for obtaining WLAN information from a WLAN modem of the mobile device and means for estimating the WLAN capacity during a polling period based on the WLAN information. In some examples, the apparatus may further include means for providing the WLAN capacity to the application on the mobile device for adjusting air-interface operations associated with the application.

According to a third set of examples, a computer readable medium storing computer executable code for wireless communication is disclosed. The computer readable medium may comprise code for triggering, by an application on a mobile device, estimation of a WLAN capacity associated with the mobile device. Based on the code for triggering, the computer readable medium may further include code for obtaining WLAN information from a WLAN modem of the mobile device and code for estimating the WLAN capacity during a polling period based on the WLAN information. In some examples, the computer readable medium may further include code for providing the WLAN capacity to the application on the mobile device for adjusting air-interface operations associated with the application.

According to a fourth set of examples, yet another apparatus for wireless communication is disclosed. The apparatus may include a transceiver configured to transmit information over on an uplink channel and receive information over a downlink channel. The apparatus may further include a memory configured to store data and at least one processor communicatively coupled to the memory and the transceiver via a bus. The at least one processor and the memory may be configured to execute instructions to process the data to trigger, by an application on a mobile device, estimation of a WLAN capacity associated with the mobile device. The apparatus may also obtain WLAN information from a WLAN modem of the mobile device and estimate the WLAN capacity during a polling period based on the WLAN information. In some examples, the apparatus may also provide the WLAN capacity to the application on the mobile device for adjusting air-interface operations associated with the application.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional component, and in which:

FIG. 1 illustrates an example of a wireless communications system for estimating WLAN capacity in accordance with various aspects of the present disclosure;

FIG. 2 shows a flowchart illustrating a method for estimating WLAN capacity in accordance with various aspects of the present disclosure;

FIG. 3 shows another flowchart illustrating a method for estimating WLAN capacity in accordance with various aspects of the present disclosure;

FIG. 4 is a schematic diagram of a communication network including an aspect of a STA that may estimate WLAN capacity in accordance with various aspects of the present disclosure;

FIG. 5 is a timing diagram illustrating various aspects of the present disclosure; and

FIG. 6 is yet another flowchart illustrating a method for estimating WLAN capacity in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It should be understood, however, that such aspect(s) may be practiced without these specific details. In an aspect, the term “component” as used herein may be one of the parts that make up a system, may be hardware, firmware, and/or software, and may be divided into other components.

As discussed above, as cellular networks have become more congested, operators are beginning to look at ways to maximize the use of available network resources. One approach may include offloading cellular and data traffic to WLAN network by utilizing unused resources, for example, unused bandwidth on the downlink and/or uplink channels on the WLAN network. However, utilizing the unused resources requires accurate estimation of the network capacity. Conventional methods fail to accurately and efficiently calculate the WLAN network capacity based on existing procedures and algorithms. Aspects of the present disclosure solve the above problem by efficiently estimating the WLAN capacity of the WLAN network by utilizing WLAN information obtained from an application program interface (API) associated with the WLAN modem. Accordingly, in some examples, the mobile device may adjust the air-interface operations of the mobile device based on WLAN capacity by determining whether to transmit a data packet (and receive the response) over a WWAN network, over a WLAN network, over both the WWAN network and the WLAN network, or over multiple WLAN networks.

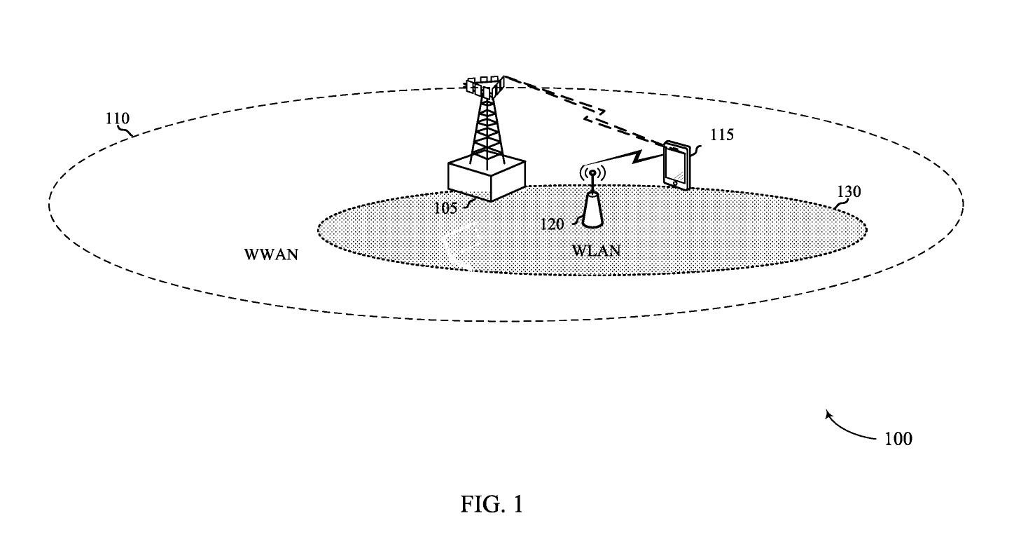

FIG. 1 illustrates an example of a wireless communications system 100 for estimating WLAN capacity in accordance with various aspects of the present disclosure. Wireless communications system 100 may include one or more mobile device(s) or STA(s) 115, a base station 105, and an access point (AP) 120. In some examples, a mobile device or STA that is estimating the WLAN network capacity may be referred to as “Device Under Test” (DUT). The base station 105 and AP 120 may perform radio configuration and scheduling for communication with the mobile device(s) 115, or may operate under the control of a base station controller (not shown). In various examples, the base station 105 and AP 120 may communicate, either directly or indirectly (e.g., through core network), with each other over backhaul links (not shown), which may be wired or wireless communication links. Additionally, the base station 105 and AP 120 may wirelessly communicate with the mobile device 115 via one or more antennas. Each of the base station 105 and AP 120 may provide communication coverage for a respective geographic coverage area. For example, the base station 105 may provide service to a first geographic coverage area 110, and the AP 120 may provide a second geographic coverage area 130. In some examples, base station 105 may be referred to as a base transceiver station, a radio base station, an access point, a radio transceiver, a NodeB, eNodeB (eNB), Home NodeB, a Home eNodeB, or some other suitable terminology.

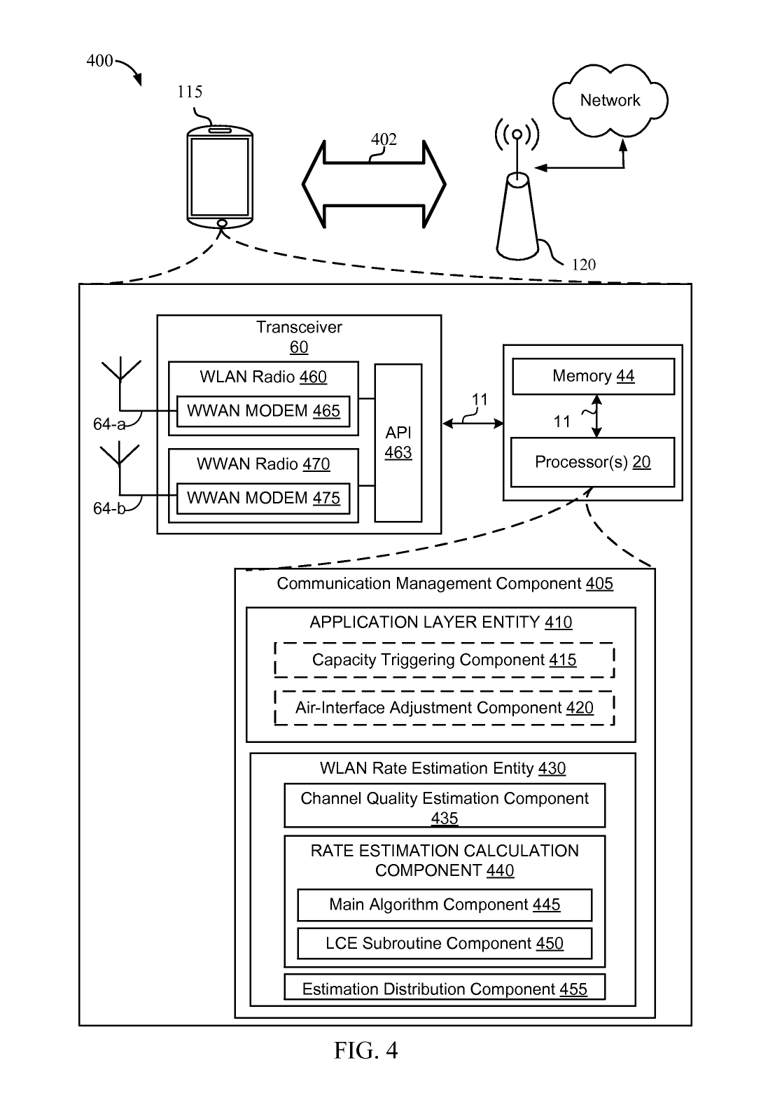

In some examples, a mobile device 115 may be a dual-radio user equipment (UE) that includes a WLAN radio 460 (FIG. 4) and a wireless wide area network (WWAN) radio 470 (FIG. 4) that may be configured to concurrently communicate with base station 105 (using the WWAN radio) and with the AP 120 (using the WLAN radio). In some examples, the mobile device 115 may concurrently communicate with the base station 105 and the AP 120 by using a licensed radio frequency band for a WWAN network (e.g., cellular network) and a separate, unlicensed radio frequency band for the WLAN communication.

In order to maximize the ability of the mobile device 115 to communicate over multiple radio access technologies (RATs) and optimize the amount of data that is communicated (e.g., download and/or upload data packets) over resources available, but not used (e.g., unused bandwidth resources), the mobile device 115 may be configured to estimate the WLAN capacity. In some examples, the term WLAN capacity may refer to a quantified measurement associated with the number of users or amount of additional data (via uplink and/or downlink channels) that the AP 120 may be configured to support.

Therefore, in some aspects, based on the estimated WLAN capacity, the mobile device 115 may adjust its air-interface operations by determining the amount of data that one or more applications associated with the mobile device 115 may transmit or receive over the WLAN network. In some examples, an application may be a set of computer programs designed to permit a user or mobile device 115 to perform a group of coordinated functions, tasks, or activities. An “application” may be, for example but not limited to, a photo sharing application and/or a mobile television application being executed on the processor of the mobile device 115. Additionally or alternatively, adjusting the air-interface operations may include determining whether to transmit a data packet (and receive the response) over the WWAN (e.g., cellular) network via base station 105, over a WLAN network via AP 120, over both WWAN network and the WLAN network or over a plurality of WLAN networks based on the WLAN capacity. In other examples, adjusting the air-interface operations may comprise identifying used and unused resources or time periods on the uplink channel and/or the downlink channel. Accordingly, one or more applications on the mobile device 115 may be configured to maximize the available resources to communicate with the network based on the estimated WLAN capacity.

Additionally or alternatively, the mobile device 115 may estimate the WLAN capacity by utilizing WLAN information obtained from an API. For instance, one or more applications associated with the mobile device 115 may obtain WLAN information (e.g., WLAN statistics and/or counters) via an API in order to estimate the WLAN downlink and uplink used and unused capacity during a polling period (e.g., 50 milliseconds). In some examples, the term “WLAN counter” and “WLAN counter value” may be used interchangeably with respect to aspects of the present disclosure. The WLAN information may be measured or otherwise obtained or determined by a WLAN modem (e.g., from a driver of the WLAN modem) that may be part of the WLAN radio in the mobile device 115 (see WLAN modem 465 of FIG. 4). The WLAN statistic may include at least one of an average received signal strength indication (RSSI) of an AP beacon and management frame, an average RSSI of an AP data frame, an average RSSI of an AP acknowledgment frame or an average data packet contention time. Conversely, the WLAN counter and/or WLAN counter value may include a counter value indicative of a time the mobile device is awake, a counter value indicative of a time the mobile device is transmitting, a counter value indicative of a time the mobile device clear channel assessment (CCA) register is busy (e.g., by determining that the medium is busy as a result of energy detection performed in connection with CCA), a counter value indicative of a number of medium access control protocol data units (MAC PDUs) received, a counter value of a number of MAC PDUs transmitted, or combination thereof.

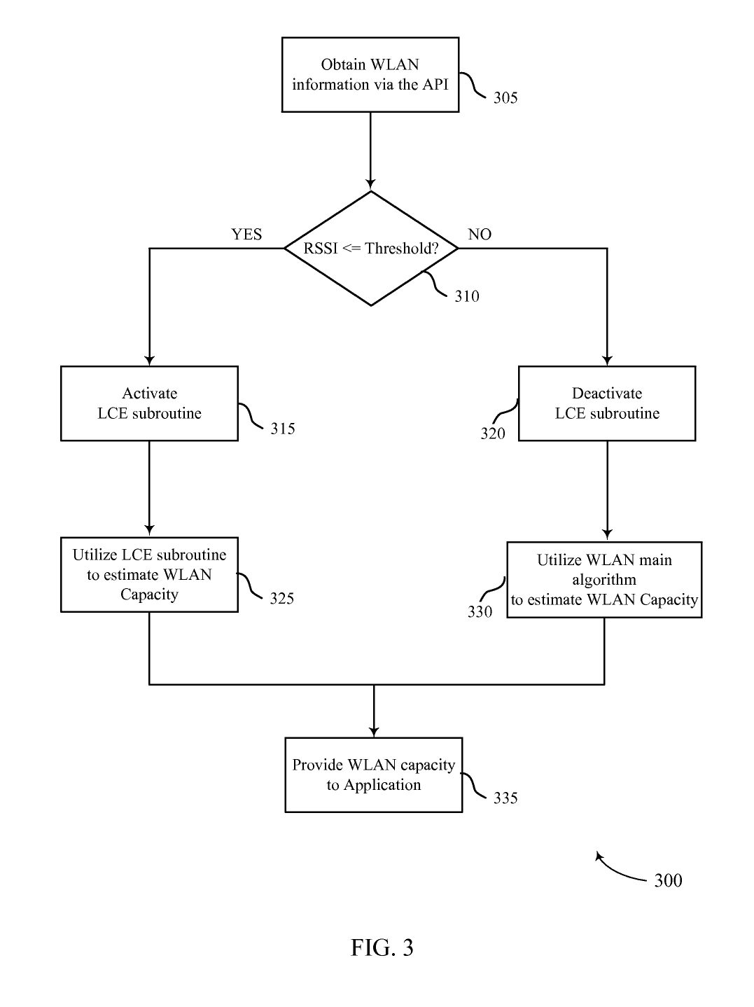

Accordingly, a WLAN rate estimation entity (see FIG. 4) may utilize the WLAN statistics and/or counters in the proposed algorithms (see FIG. 3) to accurately and efficiently estimate the WLAN capacity.

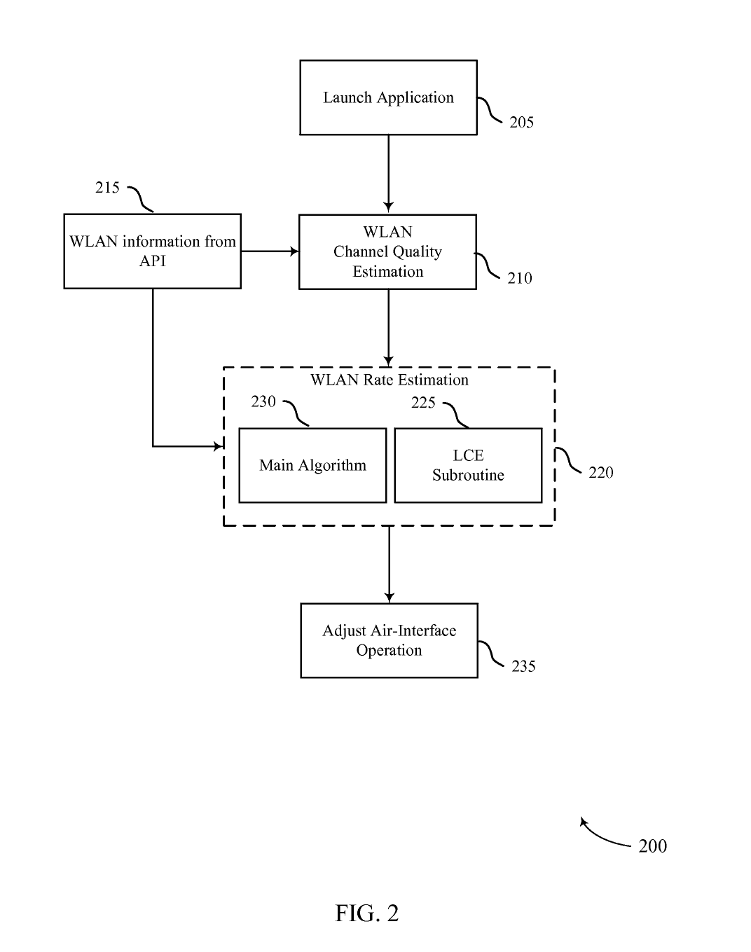

FIG. 2 shows a flowchart illustrating a method 200 for estimating WLAN capacity in accordance with various aspects of the present disclosure. The method 200 may be initiated by an application, at block 205, by triggering estimation of a WLAN capacity associated with the mobile device. In some examples, the application may require WLAN capacity information for adjusting air-interface operations associated with the application. In one example, adjusting the air-interface operations may include determining whether to transmit a data packet (and receive the response) over a WWAN network, over a WLAN network, over both the WWAN network and the WLAN network, or over multiple WLAN networks based on the WLAN capacity. In other examples, adjusting the air-interface operations may comprise identifying used and unused resources or time periods on the uplink channel and/or the downlink channel. Thus, one or more applications on the mobile device may be configured to maximize the available resources to communicate with the network based on the estimated WLAN capacity.

At block 210, the method may include determining, by a WLAN channel quality estimation component (see FIG. 4), whether received signal strength of at least one frame (e.g., RSSI of AP beacon and management frame, RSSI of AP data frame or RSSI of the AP acknowledgment frame) satisfies a threshold (e.g., −82 decibel-milliwatt (dBm)). In one or more examples, the channel quality estimation may be determined based on obtaining, at block 215, WLAN information from an API. WLAN information may include WLAN statistics and/or WLAN counters. The WLAN statistic may include at least one of an average RSSI of an AP beacon and management frame, an average RSSI of an AP data frame, an average RSSI of an AP acknowledgment frame or an average data packet contention time. Conversely, the WLAN counter may include a counter value indicative of a time the mobile device is awake, a counter value indicative of a time the mobile device is transmitting, a counter value indicative of a time the mobile device CCA register is busy, a counter value indicative of a number of medium access control protocol data units (MAC PDUs) received, a counter value of a number of MAC PDUs transmitted, or combination thereof.

In some examples, at block 210, a channel quality estimation component may determine whether to activate or deactivate low capacity estimation (LCE) subroutine based on RSSI level information received from the API. The LCE subroutine, if activated, may include calculating, at block 225, at least one of a downlink used capacity parameter or an uplink used capacity parameter (see FIG. 3). In some examples, the LCE subroutine may be a subroutine of the main algorithm. In some examples, a subroutine of the main algorithm may refer to performing a subset of the instructions or operations of the main algorithm. Accordingly, the LCE subroutine may calculate the WLAN capacity based on a subset of parameters compared to the main algorithm. For example, as discussed in FIG. 3, the LCE subroutine may estimate the WLAN capacity by calculating at least one of a downlink used capacity parameter based on Equation (1) as described with reference to FIG. 3 below or an uplink used capacity parameter based on Equation (2) as described with reference to FIG. 3 below. Comparably, the main algorithm may estimate the WLAN capacity by calculating downlink used capacity parameter based on Equation (1), an uplink used capacity parameter based on Equation (2), a downlink unused capacity parameter based on Equation (3) (see FIG. 3) and an uplink unused capacity parameter based on Equation (4) (see FIG. 3).

Additionally or alternatively, if the LCE subroutine is deactivated, WLAN capacity estimation may be calculated, at block 230, based on the main scheme or algorithm that comprises calculating at least one of a downlink used capacity parameter, an uplink used capacity parameter, a downlink unused capacity parameter or an uplink unused capacity parameter (see FIG. 3). In some examples, at block 220, the API statistics may be obtained by the WLAN rate estimation for calculating WLAN capacity based on either an LCE subroutine or the main algorithm described above.

Upon calculating the WLAN capacity, the capacity information, at block 235, may be provided to one or more applications of the mobile device to adjust the air-interface operations. In one example, adjusting the air-interface operation may comprise identifying one or more RATs to use out of those supported by the mobile device when downloading and/or uploading data. Additionally or alternatively, adjusting the air-interface operations may include determining the amount of data that one or more applications associated with the mobile device may transmit or receive over the WLAN network and/or the WWAN network.

FIG. 3 shows a flowchart illustrating a method 300 of a channel quality estimation component 435 (see FIG. 4) for determining whether to activate or deactivate LCE subroutine for WLAN capacity calculations. At block 305, the channel quality estimation component 435 may obtain WLAN information from the API. In some examples, the WLAN information may include WLAN statistics and counters received from the API. At block 310, the channel quality estimation component 435 may determine whether the RSSI information received from the API is greater than or less than or equal to a threshold. In some aspects, the threshold may be power level of −82 dBm. The threshold level may be dynamically adjusted by the one or more applications of the mobile device or be predetermined.

If, at block 310, the channel quality estimation component 435 determines that the RSSI level is less than or equal to the threshold, the channel quality estimation component may activate the LCE subroutine at block 315. Accordingly, at block 325, the WLAN capacity may be calculated based on LCE subroutine that comprises calculating at least one of a downlink used capacity parameter based on Equation (1) or an uplink used capacity parameter based on Equation (2) (see below). In one technique, the downlink used capacity parameter may be determined based on the following equation:

$${C}_{—} {used}_{—} DL = \frac{{B}_{—} rx}{{T}_{—} poll} \qquad Equation 1.0$$

In Equation (1), the B_rx may be associated with the number of data bits received by the mobile device during a polling period (T_poll) using WLAN information received from the API. In yet further example, LCE subroutine may comprise calculating an uplink used capacity parameter based on the following equation:

$${C}_{—} {used}_{—} UL = \frac{{B}_{—} tx}{{T}_{—} poll} \qquad Equation 2.0$$

In some aspects, B_tx variable in equation (2) may be number of data bits transmitted by the mobile device during the polling period (T_poll). In one or more examples, B_rx may be determined as follow:

B_rx=8>[(TCP_{DL}×TCP_data_frame_length)+(TCPAck_{DL}×TCPAck_frame_length)] Equation 2.1

Additionally or alternatively, B_tx may be determined as follow:

B_tx=8×[(TCP_{UL}×TCP_data_frame_length)+TCPAck_{UL}×TCPAck_frame_length)] Equation 2.2

With respect to the parameters defined in above equations (i.e., equations 2.1 and 2.2), TCP_{DL} may be a number of DUT TCP data frames received on the downlink during the polling period (T_poll). TCPAck_{DL} may be number of DUT TCP acknowledgment frames received on the downlink during the polling period. TCP_{UL} may be a number of DUT TCP data frames on the uplink during the polling period. TCPAck_{UL} may be a number of DUT TCP acknowledgment frames on the uplink during the polling period (T_poll). The parameter TCP_data_frame_length may be a length of TCP data frame, including the TCP header in bytes (e.g., 1538 bytes). TCPAck_frame_length may be a length of TCP acknowledgment frame comprising only TCP header in bytes (e.g., 90 bytes). In one or more examples, TCP_{DL}, TCPAck_{DL}, TCP_{UL}, and TCPAcK_{UL} may be determined as follow:

$$[ \begin{matrix}1 & 1 & 0 & 0 \\ 0 & 0 & 1 & 1 \\ 1 & 0 & 0 & - D \\ 0 & - D & 1 & 0\end{matrix} ] [ \begin{matrix}{TCP}_{DL} \\ {TCPAck}_{DL} \\ {TCP}_{UL} \\ {TCPAck}_{UL}\end{matrix} ] = [ \begin{matrix}{rxMpdu}_{—} total \\ {txMpdu}_{—} total \\ 0 \\ 0\end{matrix} ] \qquad Equation 2.3$$

In some aspects, rxMpdu_total may be a total number of MAC PDUs received by the DUT during the polling period (T_poll) calculated using WLAN information received from the API. In other examples, txMpdu_total may be a total number of MAC PDUs transmitted by the DUT during the polling period (T_poll) calculated using WLAN information from the API. Additionally or alternatively, the variable “D” may be set to any integer. For example, if delayed TCP Acknowledgments are utilized on both the downlink and uplink (e.g., one TCP Acknowledgment per two TCP data segments), then the variable “D” may be set to 2. However, in other cases (e.g., at higher WLAN data rates), the value for the variable “D” may be set to a higher value (e.g., D=10) such that one TCP acknowledgment is transmitted per 10 TCP data segments.

Additionally or alternatively, if at block 310, the channel quality estimation component 435 determines that RSSI is greater than the threshold, the channel quality estimation component 435 may, at block 320, deactivate the LCE subroutine. As a result, at block 330, the WLAN capacity may be calculated based on the WLAN main algorithm that may comprise calculating downlink used capacity parameter based on Equation (1), an uplink used capacity parameter based on Equation (2), a downlink unused capacity parameter based on Equation (3) (see below) and an uplink unused capacity parameter based on Equation (4) (see below).

In accordance with one technique, the downlink unused capacity parameter may be calculated based on the following equation:

$${C}_{—} {unused}_{—} DL = {C}_{—} {used}_{—} DL \times \frac{{T}_{—} unused}{{T}_{—} {used}_{—} DUT} \qquad Equation 3.0$$

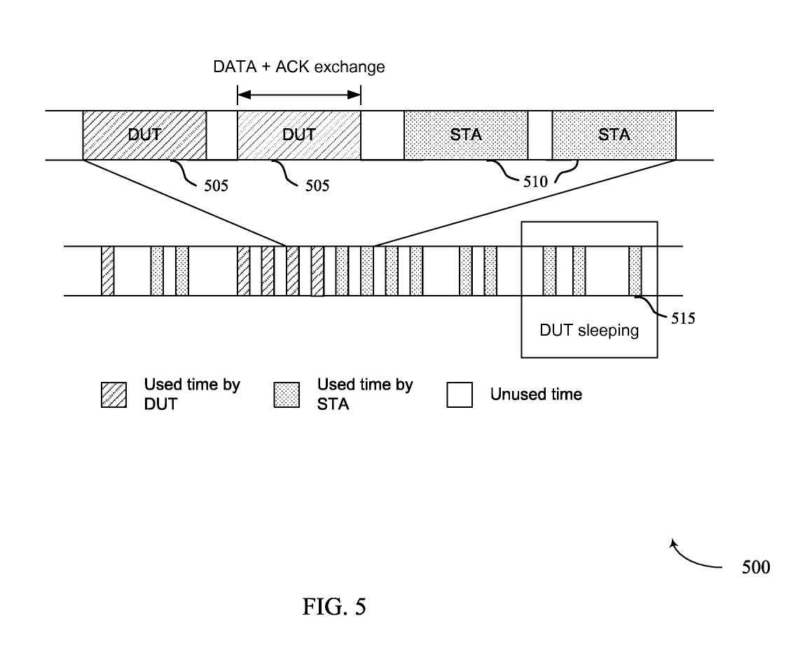

In some examples, C_used_DL may refer to the downlink used capacity parameter calculated in accordance with Equation (1). T_used_DUT parameter may be the total amount of used time during the current T_poll due to the Device Under Test (DUT). Aspects of the one or more parameters associated with the equations may be described with reference to FIG. 5 that illustrates a diagram 500 of a medium being utilized by the DUT and another STA during the polling period (T_poll). For example, T_unused parameter may be the total amount of unused time during the current T_poll where the portion of T_unused when the DUT is sleeping is extrapolated based upon the portion of T_used when the DUT is awake and the portion of T_used due to another STA when the DUT is awake. In one or more techniques, including for IEEE 802.11b, 802.11a, and 802.11g, T_used_DUT may be determined based on the following equation:

T_used_DUT=T_medium_busy_DUT+[(rxMpdu_total+txMpdu_total)×(SIFS+DIFS++AvgBO)] Equation 3.1

Additionally or alternatively, the T_used_DUT parameter for IEEE 802.11n may be determined based on the following equation:

T_used_DUT_=T_medium_busy_DUT+[(rxAmpdu_total+txAmpdu_total)×(SIFS+ALFS+AvgBO)] Equation 3.2

In some examples, T_medium_busy_DUT may be amount of time that the medium is busy due to the DUT (see FIG. 5, element 505) during the polling period (T_poll). In other examples, “rxMpdu_total” parameter may refer to the total number of MAC PDUs received by the DUT during the polling period (T_poll) calculated using WLAN information received from the API. Additionally or alternatively the “txMpdu_total” parameter may refer to a total number of MAC PDUs transmitted by the DUT during the polling period (T_poll) calculated using WLAN information from the API. In other examples, the parameter “rxAmpdu_total” may refer to a total number of A-MPDUs received by the DUT during the polling period (T_poll) calculated using WLAN information received from the API. Alternatively, the parameter “txAmpdu_total” may refer to total number of A-MPDUs transmitted by the DUT during the polling period (T_poll) calculated using WLAN information from the API. The short interframe space (SIFS) parameter value may be an adjustable integer value configured based on the type of device. For example, for IEEE 802.11n devices, the SIFS value may be set to 10 microseconds (e.g., in 2.4 GHz band) and 16 microseconds (e.g., in 5 GHz band). In other example, DCF interframe space (DIFS) parameter may be variable and set to, for example, 10 microseconds for 802.11b, 34 microseconds for 802.11.a, 28 microseconds for 802.11g devices. Alternatively, the arbitration inter-frame spacing (AIFS) parameter value may be obtained from the WLAN AP broadcast channel. The “AvgBO” value may refer to an average amount of backoff time spent by the DUT during the polling period (T_poll) calculated using WLAN information received from the API or determined via preconfiguration.

In accordance with the present disclosure, the WLAN main algorithm may further be configured to calculated the uplink unused capacity parameter according to the following equation:

$${C}_{—} {unused}_{—} U L = {C}_{—} {used}_{—} U L \times \frac{{T}_{—} unused}{{T}_{—} {used}_{—} DUT} \qquad Equation 4.0$$

In some aspects, C_used_UL value may be based on the uplink used capacity parameter calculated above in accordance with equation (2). As discussed above, T_used_DUT may be the total amount of used time during the current T_poll due to the DUT and T_unused parameter may be the total amount of unused time during the current T_poll. In some aspects, during the period that DUT is sleeping, the T_unused parameter is extrapolated based upon determination of the portion of time that the medium is used by the DUT and the STA (see FIG. 5, elements 505 and 510) when DUT is awake. For example, the T_unused parameter may be determined according to the following equation:

T_unused=T_unused_DUT_awake+T_unused_DUT_sleep Equation 4.1

In some aspects, the “T_unused_DUT awake” parameter may be calculated based on the following equation:

T_unused_DUT_awake=on_time−T_used_DUT Equation 4.2

In yet further examples, the parameter T_unused_DUT_Sleep may be determined based on the following equation:

T_unused_DUT_sleep=T_poll−on_time−T_used_STA_DUT_sleep Equation 4.3

In one or more examples of the above equations, the parameter “on_time” may refer to the amount of time in microseconds that the DUT may be awake during the polling period (T_poll) calculated using the WLAN information receiving from the API. In some aspects, “T_used_STA_DUT_sleep” parameter may be an amount of time (e.g., in microseconds) used by another STA(s) (see FIG. 5, element 515) during the polling period (T_poll) when the DUT may be sleeping. In one technique, the “T_used_STA_DUT_sleep” parameter may be determined based on the following equation:

$${T}_{—} {used}_{—} {STA}_{—} {DTU}_{—} sleep = \frac{\begin{matrix}{T}_{—} {used}_{—} {STA}_{—} {DUT}_{—} awake \times \\ ( {T}_{—} poll - {on}_{—} time )\end{matrix}}{\begin{matrix}{T}_{—} {used}_{—} {STA}_{—} {DUT}_{—} awake + \\ {T}_{—} {unused}_{—} {DUT}_{—} awake\end{matrix}} \qquad Equation 4.4$$

In some aspects, the “T_used_STA_DUT_awake” parameter may be calculated based on the following equation (e.g., for IEEE 802.11b, 802.11a, and 802.11g devices):

T_used_STA_DUT_awake=T_medium_busy_STA+(TCP_{STA}+TCPAck_{STA})×(SIFS+DIFS+AvgBO) Equation 4.5

Additionally or alternatively, the “T_used_STA_DUT_awake” parameter may be calculated based on the following equation (e.g., for IEEE 802.11n):

T_used_STA_DUT_awake=T_medium_busy_STA+(TCP_{STA}+TCPAck_{STA})×(SIFS+AIFS+AvgBO) Equation 4.6

In one or more examples, the parameter “T_medium_busy_STA” described in equation 4.5 may be calculated based on the following equation:

T_medium_busy_STA=(cca_busy_time+tx_time)−T_medium_busy_DUT Equation 4.7

In yet further examples, the TCP_{STA} parameter may be number of TCP data frames on both the downlink and the uplink associated with another STA during the polling period (T_poll). In yet further aspects, TCPAck_{STA} may reference number of TCP acknowledgement frames on both the downlink and uplink associated with another STA during the polling period. The parameters “SIFS,” “DIFS” and “AvgBO” may be similar to those as described above with reference to equation 3.1. In some aspects, the parameter AIFS value may be obtained from the WLAN AP broadcast channel. The parameter “cca_busy_time” may reference an amount of time that the DUT clear channel assessment (CCA) register is busy during the polling period (T_poll) calculated using WLAN information received from the API. The parameter “tx_time” may be an amount of time that the DUT may be transmitting during the polling period (T_poll) calculated using the WLAN information received from the API.

Accordingly, the method 300, at block 335, may provide the calculated WLAN capacity to one or more application(s) executing on the mobile device 115 in order to allow the one or more application(s) to adjust air-interface operations of the mobile device 115 based on the WLAN capacity.

Referring now to FIG. 4, in an aspect, a wireless communication system 400 includes at least one mobile device 115 in communication coverage of at least one network entity 120 (e.g., AP 120 of FIG. 1). In some examples, the mobile device 115 may be an example of mobile device 115 described with reference to FIG. 1. The mobile device 115 may communicate with network via network entity 120. In an example, mobile device 115 may transmit and/or receive wireless communication to and/or from network entity 120 via one or more communication channels 402, which may include an uplink communication channel (or simply uplink channel) and a downlink communication channel (or simply downlink channel), such as but not limited to an uplink data channel and/or downlink data channel. Such wireless communications may include, but are not limited to, data, audio and/or video information.

In accordance with the present disclosure, mobile device 115 may include a memory 44, one or more processors 20 and a transceiver 60. The memory, one or more processors 20 and the transceiver 60 may communicate internally via a bus 11. In some examples, the memory 44 and the one or more processors 20 may be part of the same hardware component. Alternatively, the memory 44 and the one or more processors 20 may be separate components that may act in conjunction with one another. In some aspects, the bus 11 may be a communication system that transfers data between multiple components and subcomponents of the mobile device 115. In some examples, the one or more processors 20 may include any one or combination of modem processor, baseband processor, digital signal processor and/or transmit processor. Additionally or alternatively, the one or more processors 20 may include a communication management component 405 for carrying out one or more methods or procedures described herein. The communication management component 405 may comprise hardware, firmware, and/or software and may be configured to execute code or perform instructions stored in a memory (e.g., a computer-readable storage medium).

In some examples, the mobile device 115 may include the memory 44, such as for storing data used herein and/or local versions of applications or communication management component 405 and/or one or more of its subcomponents being executed by the one or more processors 20. Memory 44 can include any type of computer-readable medium usable by a computer or processor 20, such as random access memory (RAM), read only memory (ROM), tapes, magnetic discs, optical discs, volatile memory, non-volatile memory, and any combination thereof. In an aspect, for example, memory 44 may be a computer-readable storage medium (e.g., a non-transitory medium) that stores one or more computer-executable codes defining communication management component 405 and/or one or more of its subcomponents, and/or data associated therewith, when mobile device 115 is operating processor 20 to execute communication management component 405 and/or one or more of its subcomponents. In some examples, the mobile device 115 may further include a transceiver 60 for transmitting and/or receiving one or more data and control signals to/from the network via AP 120. The transceiver 60 may comprise hardware, firmware, and/or software and may be configured to execute code or perform instructions stored in a memory (e.g., a computer-readable storage medium). The transceiver 60 may include a WLAN radio 460 comprising a WLAN modem 465, and a WWAN radio 470 (e.g., LTE radio) comprising a WWAN modem 475. The WLAN radio 460 and WWAN radio 470 may utilize one or more antennas 64 for transmitting signals to and receiving signals from the AP 120.

In some examples, the communication management component 405 may include an application layer entity 410 that may be an application stored on mobile device 115 (e.g., on the memory 44) and executed by the one or more processors 20 of the mobile device 115, including any application that generates data for transmission by the WLAN modem 465 and/or WWAN modem (e.g., cellular or LTE modem) 475. The application layer entity 410 may comprise a capacity triggering component 415 for triggering WLAN capacity estimation procedures and/or an air-interface adjustment component 420 for adjusting air-interface operations.

In some aspects, adjusting air-interface operations may include adjusting data transmission rate or determining whether to transmit or receive a signal (e.g., data packet) over a cellular network via WWAN radio 470, over a WLAN network via WLAN radio 460, over both the cellular network and the WLAN network, or over two WLAN networks based on the WLAN capacity. In some aspects, the air-interface adjustment component 420 may take into account uplink communication characteristic information associated with transmissions on the uplink communication channel and/or downlink communication characteristic information associated with the downlink communication channel. The air-interface adjustment component 420 may comprise hardware, firmware, and/or software and may be configured to execute code or perform instructions stored in a memory (e.g., a computer-readable storage medium). In some examples, the uplink communication characteristic information affects an amount of data that application layer entity 410 may be able to send to the WLAN modem 465 and/or WWAN modem 475 for transmission over the uplink communication channel. Similarly, the downlink communication characteristic information affects the amount of data that application layer entity 410 may be able to receive from the modem 465 and/or WWAN modem 475 over the downlink communication channel.

In some examples, mobile device 115 may include a WLAN radio 460 comprising a WLAN modem 465. Additionally or alternatively, the mobile device 115 may also include a WWAN radio 470 (e.g., LTE radio) comprising a WWAN modem 475. In some aspects, the WLAN rate estimation entity 430 may be configured to use WLAN information (e.g., WLAN statistics and/or WLAN counters) measured by the WLAN modem 465 to estimate the downlink and uplink used and unused capacity during a polling period (e.g., every 50 milliseconds). The WLAN rate estimation entity 430 may comprise hardware, firmware, and/or software and may be configured to execute code or perform instructions stored in a memory (e.g., a computer-readable storage medium). In some examples, the WLAN information may be obtained from a modem WLAN modem 465 software driver via application programming interface (API) 463. The WLAN statistics include at least one of an average received signal strength indication (RSSI) of an access point (AP) beacon and management frame, an average RSSI of an AP data frame, an average RSSI of an AP acknowledgment frame or an average data packet contention time. Additionally or alternatively, the WLAN counter may include a counter value indicative of a time the mobile device is awake, a counter value indicative of a time the mobile device is transmitting, a counter value indicative of a time the mobile device clear channel assessment (CCA) register is busy, a counter value indicative of a number of medium access control protocol data units (MAC PDUs) received, a counter value of a number of MAC PDUs transmitted, or combination thereof

In one or more examples, WLAN rate estimation entity 430 includes a channel quality estimation component 435. The channel quality estimation component 435 may comprise hardware, firmware, and/or software and may be configured to execute code or perform instructions stored in a memory (e.g., a computer-readable storage medium). In some examples, the channel quality estimation component 435 may be configured to identify, from the WLAN information, received signal strength from at least one frame (e.g., AP beacon and management frame, AP data frame and/or AP acknowledgment frame). In some aspects, the channel quality estimation component 435 may determine whether the received signal strength satisfies a threshold (e.g., power ratio −82 decibel-milliwatts). In one example, the power ratio for satisfying the threshold may be dynamically adaptable by the application layer entity 510. In other examples, the threshold may be predetermined.

Accordingly, in some examples, the channel quality estimation component 435 may activate low capacity estimation (LCE) subroutine component 450 if the RSSI level decreases below the −82 dBm threshold. In some examples, the LCE subroutine component 450 may be an example of LCE subroutine 225 described with reference to FIG. 2 and method of block 325 described with reference to FIG. 3. Alternatively, the channel quality estimation component 435 may deactivate the LCE subroutine component 450 if the RSSI is above the −82 dBm threshold.

The communication management component 405 may additionally include a rate estimation calculation component 440. The rate estimation calculation component 440 may comprise hardware, firmware, and/or software and may be configured to execute code or perform instructions stored in a memory (e.g., a computer-readable storage medium). The rate estimation component 440 calculates the WLAN capacity by utilizing the main algorithm component 454 and LCE subroutine component 450. Thus, in accordance with the present disclosure, the LCE subroutine component 450, when activated, may estimate WLAN capacity during a polling period using parameters from a subset of parameters associated with the WLAN capacity. In some examples, estimating WLAN capacity using parameters from a subset of parameters may include calculating at least one of a downlink used capacity parameters or an uplink used capacity parameter. Conversely, if the LCE subroutine component 450 is deactivated (e.g., if the RSSI is above the threshold), the rate estimation calculation component 440 may utilize the main algorithm component 445 to calculate the WLAN capacity. In some examples, the main algorithm component 445 may be an example of main algorithm 230 described with reference to FIG. 2 and a method of block 330 described with reference to FIG. 3. The main algorithm component 445 may estimate WLAN capacity by calculating at least one of a downlink used capacity parameter, an uplink used capacity parameter, a downlink unused capacity parameter or an uplink unused capacity parameter.

In some examples, the WLAN rate estimation entity 430 may include an estimation distribution component 455 for providing the calculated WLAN capacity to one or more applications being executed on the application layer entity 410. The estimation distribution module 455 may comprise hardware, firmware, and/or software and may be configured to execute code or perform instructions stored in a memory (e.g., a computer-readable storage medium). Accordingly, the calculated WLAN capacity may be utilized by the air-interface adjustment component 420 of the application layer entity 410 to adjust the air-interface operations described above. In some examples, the air-interface adjustment component 420 may adjust the operation of the WLAN radio 460 and/or WWAN radio 470 by determining the amount of data to transmit via each respective modem. In other examples, the air-interface adjustment component 420 may utilize the estimated WLAN capacity to identify the unused bandwidth in the existing network resources to schedule transmission or reception of data packets in the uplink and/or downlink channels 402.

Additionally, as used herein, the one or more wireless nodes, including, but not limited to, network entity 120 of wireless communication system 400, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 500 may include one or more small cell base stations, such as, but not limited to a femtocell, picocell, microcell, or any other base station having a relatively small transmit power or relatively small coverage area as compared to a macro base station.

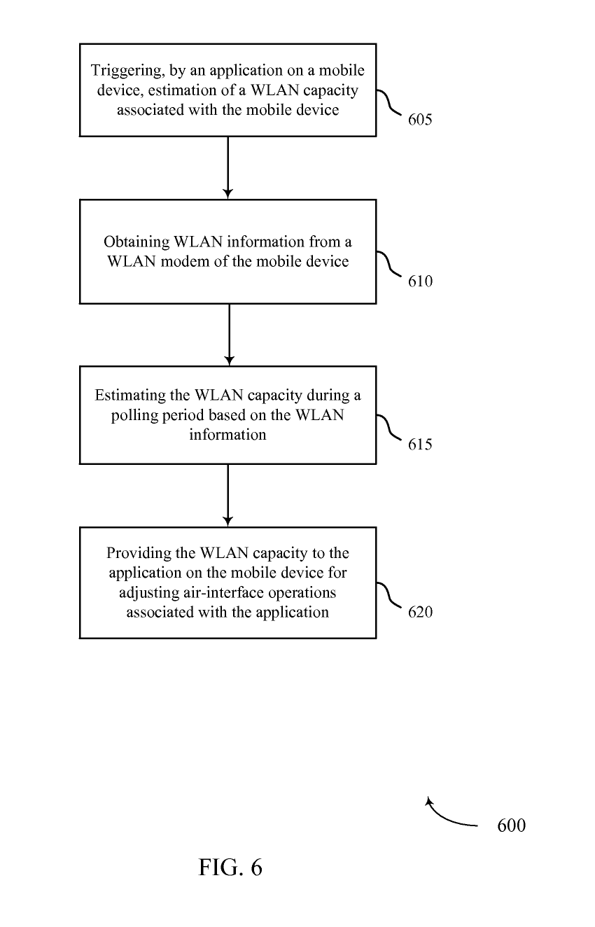

FIG. 6 presents an exemplary methodology 600 comprising a non-limiting set of operations represented as blocks that may be performed by one or more apparatuses described herein (e.g. a communication management component 405). In an aspect, methodology 600 may comprise a method of estimating WLAN capacity. At block 605, the method may include triggering, by an application on a mobile device, estimation of a WLAN capacity associated with the mobile device. In some examples, aspects of block 605 may be performed by application layer entity 410, and more specifically the capacity triggering component 415 described with reference FIG. 4. In one example, the capacity triggering component 415 may trigger the WLAN capacity estimation upon determining that the mobile device may optimize unused bandwidth of the uplink and/or downlink channels. In some examples, the capacity trigging component 415 may trigger the WLAN capacity estimation by transmitting a signal or an instruction to the WLAN rate estimation entity 430 to initiate WLAN capacity estimation. Additionally or alternatively, the capacity triggering component 415 may trigger the WLAN capacity estimation upon launching an application (e.g., video conference application) on the mobile device that may require network accessibility.

In some examples, at block 610, the method may include obtaining WLAN information from a WLAN modem of the mobile device. Aspects of block 610 may be performed by WLAN modem 465 and/or channel quality estimation component 435. In some examples, the channel quality estimation component 435 may receive the WLAN information measured by the WLAN modem 465. For example, the WLAN modem 465, during a polling period, may extract WLAN information (e.g., WLAN statistics and/or counters) from WLAN modem 465 hardware or firmware via an API 463. The WLAN statistics and/or counters may be forwarded to the channel quality estimation component 435 to aid in the WLAN capacity estimation.

At block 615, the method may include estimating the WLAN capacity during a polling period based on the WLAN information. Aspects of block 515 may be performed by WLAN rate estimation entity 440. The WLAN rate estimation entity 440 may utilize the received WLAN information to estimate the WLAN capacity via calculations by either the main algorithm or LCE subroutine discussed above with reference to FIG. 2-3.

In yet further examples, the method, at block 620, may further include providing the WLAN capacity to the application on the mobile device for adjusting air-interface operations associated with the application. Aspects of block 620 may be performed by the estimation distribution component 455. In some examples, the estimation distribution component 455 may relay the information between the application layer entity 410 and the WLAN rate estimation entity 430 in order to allow the application layer entity 410 to adjust the air-interface operations of the mobile device 115 based on the estimated WLAN capacity.

The detailed description set forth above in connection with the appended drawings describes example embodiments and does not represent all the embodiments that may be implemented or that are within the scope of the claims. The term “exemplary,” as used in this description, means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but are to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile Communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method for wireless communications, comprising:
triggering, by an application on a mobile device, estimation of a wireless local area network (WLAN) capacity associated with the mobile device;
obtaining WLAN information from a WLAN modem of the mobile device;
estimating the WLAN capacity during a polling period based on the WLAN information; and
providing the WLAN capacity to the application on the mobile device for adjusting air-interface operations associated with the application.

2. The method of claim 1, wherein obtaining the WLAN information from the WLAN modem of the mobile device comprises:
obtaining the WLAN information from a WLAN modem driver associated with the WLAN modem via an application programming interface (API).

3. The method of claim 1, wherein estimating the WLAN capacity comprises:
identifying, from the WLAN information, a received signal strength of at least one frame; and
activating estimation of parameters from a subset of parameters associated with the WLAN capacity when the received signal strength is less than a threshold.

4. The method of claim 3, wherein activating estimation of parameters from the subset of parameters associated with the WLAN capacity comprises:
calculating at least one of a downlink used capacity parameter or an uplink used capacity parameter.

5. The method of claim 1, wherein estimating the WLAN capacity further comprises:
deactivating the estimation of parameters from the subset of parameters associated with the WLAN capacity when the received signal strength is greater than the threshold.

6. The method of claim 1, wherein estimating the WLAN capacity comprises:
activating estimation of parameters from a set of parameters associated with the WLAN capacity, wherein the estimation comprises calculating at least one of a downlink used capacity parameter, an uplink used capacity parameter, a downlink unused capacity parameter or an uplink unused capacity parameter.

7. The method of claim 1, wherein adjusting the air-interface operations associated with the application comprises:
determining, by the application, whether to communicate a signal over a cellular network, over a first WLAN network, over both the cellular network and the first WLAN network, or over the first WLAN network and a second WLAN network based on the WLAN capacity; and
communicating the signal over the cellular network, over the first WLAN network, over both the cellular network and the first WLAN network, or over the first WLAN network and the second WLAN network based on the determining, wherein communicating the signal comprises either transmitting or receiving the signal.

8. The method of claim 1, wherein the WLAN information comprises a WLAN statistic, a WLAN counter, or combination thereof.

9. The method of claim 8, wherein the WLAN statistic includes at least one of an average received signal strength indication (RSSI) of an access point (AP) beacon and management frame, an average RSSI of an AP data frame, an average RSSI of an AP acknowledgment frame or an average data packet contention time.

10. The method of claim 8, wherein the WLAN counter includes a counter value indicative of a time the mobile device is awake, a counter value indicative of a time the mobile device is transmitting, a counter value indicative of a time the mobile device clear channel assessment (CCA) register is busy, a counter value indicative of a number of medium access control protocol data units (MAC PDUs) received, a counter value of a number of MAC PDUs transmitted, or combination thereof.

11. An apparatus for wireless communications, comprising:
means for triggering, by an application on a mobile device, estimation of a wireless local area network (WLAN) capacity associated with the mobile device;
means for obtaining WLAN information from a WLAN modem of the mobile device;
means for estimating the WLAN capacity during a polling period based on the WLAN information; and
means for providing the WLAN capacity to the application on the mobile device for adjusting air-interface operations associated with the application.

12. The apparatus of claim 11, wherein means for obtaining the WLAN information from the WLAN modem of the mobile device comprises:
means for obtaining the WLAN information from the WLAN modem driver associated with the WLAN modem via an application programming interface (API).

13. The apparatus of claim 11, wherein the means for estimating the WLAN capacity comprises:
means for identifying, from the WLAN information, a received signal strength of at least one frame; and
means for activating estimation of parameters from a subset of parameters associated with the WLAN capacity when the received signal strength is less than a threshold.

14. The apparatus of claim 13, wherein means for activating estimation of parameters from the subset of parameters associated with the WLAN capacity comprises:
means for calculating at least one of a downlink used capacity parameter or an uplink used capacity parameter.

15. The apparatus of claim 11, wherein means for estimating the WLAN capacity further comprises:
means for deactivating the estimation of parameters from the subset of parameters associated with the WLAN capacity when the received signal strength is greater than the threshold.

16. The apparatus of claim 11, wherein means for estimating the WLAN capacity comprises:
means for activating estimation of parameters from a set of parameters associated with the WLAN capacity, wherein the estimation comprises calculating at least one of a downlink used capacity parameter, an uplink used capacity parameter, a downlink unused capacity parameter or an uplink unused capacity parameter.

17. The apparatus of claim 11, wherein means for adjusting the air-interface operations associated with the application comprises:
means for determining, by the application, whether to communicate a signal over a cellular network, over a first WLAN network, over both the cellular network and the first WLAN network, or over the first WLAN network and a second WLAN network based on the WLAN capacity; and
communicating the signal over the cellular network, over the first WLAN network, over both the cellular network and the first WLAN network, or over the first WLAN network and the second WLAN network based on the determining, wherein communicating the signal comprises either transmitting or receiving the signal.

18. The apparatus of claim 11, wherein the WLAN information comprises a WLAN statistic, a WLAN counter, or combination thereof.

19. The apparatus of claim 18, wherein the WLAN statistic includes at least one of an average received signal strength indication (RSSI) of an access point (AP) beacon and management frame, an average RSSI of an AP data frame, an average RSSI of an AP acknowledgment frame or an average data packet contention time.

20. The apparatus of claim 18, wherein the WLAN counter includes a counter value indicative of a time the mobile device is awake, a counter value indicative of a time the mobile device is transmitting, a counter value indicative of a time the mobile device clear channel assessment (CCA) register is busy, a counter value indicative of a number of medium access control protocol data units (MAC PDUs) received, a counter value of a number of MAC PDUs transmitted, or combination thereof.

21. An apparatus for wireless communications, comprising:
a transceiver configured to transmit information over on an uplink channel and receive information over a downlink channel;
a memory configured to store data; and
at least one processor communicatively coupled to the memory and the transceiver via a bus, the at least one processor and the memory configured to execute instructions to process the data to:
trigger, by an application on a mobile device, estimation of a wireless local area network (WLAN) capacity associated with the mobile device;
obtain WLAN information from a WLAN modem of the mobile device;
estimate the WLAN capacity during a polling period based on the WLAN information; and
provide the WLAN capacity to the application on the mobile device for adjusting air-interface operations associated with the application.

22. The apparatus of claim 21, wherein the at least one processor and the memory configured to:
obtain the WLAN information from the WLAN modem driver associated with the WLAN modem via an application programming interface (API).

23. The apparatus of claim 21, wherein the at least one processor and the memory configured to:
identify, from the WLAN information, a received signal strength of at least one frame; and
activate estimation of parameters from a subset of parameters associated with the WLAN capacity when the received signal strength is less than a threshold.

24. The apparatus of claim 23, wherein the at least one processor and the memory configured to:
calculate at least one of a downlink used capacity parameter or an uplink used capacity parameter.

25. The apparatus of claim 21, wherein the at least one processor and the memory configured to:
deactivate the estimation of parameters from the subset of parameters associated with the WLAN capacity when the received signal strength is greater than the threshold.

26. The apparatus of claim 21, wherein the at least one processor and the memory configured to:
activate estimation of parameters from a set of parameters associated with the WLAN capacity, wherein the estimation comprises calculating at least one of a downlink used capacity parameter, an uplink used capacity parameter, a downlink unused capacity parameter or an uplink unused capacity parameter.

27. The apparatus of claim 21, wherein the at least one processor and the memory configured to:
determine, by the application, whether to communicate a signal over a cellular network, over a first WLAN network, over both the cellular network and the first WLAN network, or over the first WLAN network and a second WLAN network based on the WLAN capacity; and
communicating the signal over the cellular network, over the first WLAN network, over both the cellular network and the first WLAN network, or over the first WLAN network and the second WLAN network based on the determining, wherein communicating the signal comprises either transmitting or receiving the signal.

28. The apparatus of claim 21, wherein the WLAN information comprises a WLAN statistic, a WLAN counter, or combination thereof.

29. The apparatus of claim 28, wherein the WLAN statistic includes at least one of an average received signal strength indication (RSSI) of an access point (AP) beacon and management frame, an average RSSI of an AP data frame, an average RSSI of an AP acknowledgment frame or an average data packet contention time.

30. A computer-readable medium storing code for wireless communications, the code comprising instructions executable to:
trigger, by an application on a mobile device, estimation of a wireless local area network (WLAN) capacity associated with the mobile device;
obtain WLAN information from a WLAN modem of the mobile device;
estimate the WLAN capacity during a polling period based on the WLAN information; and
provide the WLAN capacity to the application on the mobile device for adjusting air-interface operations associated with the application.
